(19) United States
(12) Patent Application Publication
(10) Pub. No.: US 2001/0051568 A1
(43) Pub. Date: Dec. 13, 2001

(54) Method, machine and stock material for making folded strips

(76) Inventor: Michael J. Lencoski, Claridon Township, OH (US)

Correspondence Address: Dunlap, Codding & Rogers, P.C., Suite 420, 9400 North Broadway, Oklahoma City, OK, 73114, US

(21) Appl. No.: 09/727,631

(22) Filed: Dec. 1, 2000

Related U.S. Application Data
(63) Continuation of application No. 08/940,610, filed on Sep. 30, 1997, now abandoned.

(51) Int. Cl. B31B 1/14

(52) U.S. Cl. 493/967

(57) ABSTRACT

A method and machine for making a plurality of accordion-folded strips each having a predetermined unfolded length. A sheet of material is longitudinally and transversely separated into a plurality of strips and the strips are folded into a plurality of accordion-folded strips. The method/machine are characterized by the transverse separation of the strip occurring at completion of the longitudinal separation.

### FIELD OF THE INVENTION

The invention herein described relates generally to a method and a machine for making folded strips, a stock material for making folded strips, and a plurality of folded strips made from such a method/machine/stock material.

### BACKGROUND OF THE INVENTION

Accordion-folded paper strips heretofore have been used as decorative packaging, dunnage, void-fill and other cushioning products. Accordion-folded paper strips have also recently found uses in other areas, such as the agricultural and veterinary fields.

Methods and machines for making such folded strips are disclosed in U.S. Pat. Nos. 5,088,972; 5,134,013; 5,173,352; 5,403,259; 5,573,491; and 5,656,008 and in U.S. patent application Ser. No. 08/153,360. (These patents and applications are assigned to the assignee of the present application and their entire disclosures are hereby incorporated by reference.) In these methods and machines, a continuous sheet of material is separated into a plurality of strips and folded into a zig-zag or accordion shape. The folding is accomplished by advancing the plurality of strips against a restriction in such a manner that the natural resilience of the material produces adjacent opposite folds thereby causing the strips to assume a zig-zag or accordion shape. The separation of the sheet of material into strips is accomplished by transverse separation which defines the unfolded lengths of the strips and longitudinal separation which defines the unfolded width of the strips. The width of the folded strip will be the same as the width of the unfolded strip. The length of the folded strip will be somewhat shorter than the length of the unfolded strip.

The separation of the continuous sheet of material into a plurality of strips has been accomplished in different ways. For example, in U.S. Pat. Nos. 5,088,972 and 5,134,013, a method and machine is disclosed in which a continuous sheet or web of material is first longitudinally cut into a plurality of continuous longitudinal segments. These continuous segments are folded and then subsequently transversely separated into folded strips. Thus, the transverse separation of the strip from the sheet material occurs after its longitudinal separation and folding. Due to the nature of the folding process and the resulting random orientation of the strips, it is difficult if not impossible to produce folded strips of the same and/or a specified unfolded length with such a post-folding transverse separation.

Alternatively, in U.S. Pat. Nos. 5,173,352 and 5,403,259, a method and machine is disclosed in which a leading rectangular portion of the continuous sheet of paper is completely transversely separated from the rest of the sheet of paper to acquire the desired unfolded length of the strips. This leading portion is longitudinally slit into a plurality of strips which are then folded into folded strips.

### SUMMARY OF THE INVENTION

The present invention involves the discovery of a problem relating to the production of relatively short folded strips (folded strips having a relatively short unfolded length). Such strips are desirable, for example, to produce a “pourable” product as opposed to one in which longer strips intertwine and interconnect. When producing “shorter” folded strips, the prior methods and machines will not always produce acceptable folded strips. Specifically, if the shorter strips are to be of the same and/or specified unfolded lengths, the post-folding transverse separation method/machine set forth in U.S. Pat. Nos. 5,088,972 and 5,134,013 will probably not produce an acceptable product. As for the pre-folding transverse separation method/machine set forth in U.S. Pat. Nos. 5,173,352 and 5,403,259, shorter strips requires a shorter leading portion of the sheet material (since it defines the unfolded length of the strips). This increases the risk of premature separation and/or misfeeding during longitudinal separation of the strip.

The present invention provides a method/machine for making a plurality of accordion-folded strips each having a predetermined unfolded length. In this method/machine, a sheet of material is longitudinally and transversely separated into a plurality of strips each having a predetermined unfolded length and the strips are folded into a plurality of accordion-folded strip. The method/machine is characterized by the transverse separation of the strip occuring at completion of the longitudinal separation of the strip. Because the transverse separation of the strip occurs at completion of the longitudinal separation, the risk of premature separation and/or misfeeding during the longitudinal separation of the strip is minimized while still producing a plurality of accordion-folded strips each having a predetermined unfolded length.

The longitudinally and transversely separating step may be accomplished by supplying a pre-cut sheet material according to the present invention and then longitudinally severing the precut sheet material. The pre-cut sheet material comprises a substantially planar sheet having a plurality of columns of longitudinally aligned associated cuts. The cuts are arranged in transverse rows and each row includes a plurality of cuts separated by a length of uncut material. The cuts in adjacent rows are longitudinally offset and are arranged to prevent expansion and deformation of the sheet material. Alternatively, the precut material comprises a substantially planar sheet having a plurality of transverse rows of cuts, each of the cuts having a non-perpendicular and non-zero angle relative to a longitudinal dimension of the sheet.

The pre-cut sheet material may be formed at the same location as the separation and folding of the strips. For example, a machine according to the present invention includes a transverse severing assembly which cuts a plurality of cuts forming longitudinal columns of longitudinally aligned associated cuts in a sheet material, a longitudinal severing assembly, located downstream of the transverse severing assembly, which longitudinally severs the sheet of material to form a plurality of strips of the predetermined unfolded lengths, and a folding device, located downstream of the longitudinal severing assembly which causes the folding of the strips into a plurality of accordion-folded strips. The machine's transverse severing assembly arranges the cuts so that transverse separation of each strip occurs at completion of its longitudinal separation.

Alternatively, the pre-cut sheet material may be produced at one location and then transported to a remote location for the separation and folding of the strips. In this manner, a machine at the remote location could omit a transverse severing assembly and still produce accordion-folded strips each having a predetermined unfolded length. For example, the method of the present invention could be incorporated into or used in conjunction with a machine, such as the one disclosed in U.S. application No. ______ to Richard O. Ratzel, filed concurrently with the present application and entitled CONVERSION MACHINE AND METHOD FOR MAKING FOLDED STRIPS, which is hereby incorporated by this reference in its entirety. Accordingly, irrespective of the desired unfolded length of the strips, the present invention provides other advantages and solutions not found in the prior art methods/machines.

The present invention also provides for accordion folded strips which have a non-rectangular unfolded shape, as may be desirable in certain situations. Particularly, accordion folded strips according to the present invention comprise lengths of sheet material formed into a plurality of transverse folds. At least some of the lengths of sheet material have a predetermined unfolded state in which transverse edges are non-perpendicularly sloped relative to the longitudinal edges of the length of material whereby at least some of the strips have a non-rectangular unfolded shape. For example, the unfolded shape of at least some of the strips may be a parallelogram or a trapezoid. The present invention additionally or alternatively provides intermixed accordion folded strips in which the strips have predetermined, but different, unfolded lengths. Although the post-folding separation of strips by the method/machine disclosed in U.S. Pat. Nos. 5,088,972 and 5,134,013 may incidently produce strips having different lengths and non-rectangular unfolded shapes, such shapes and lengths are random, unpredictable, and thus not predetermined. As for the pre-folding transverse separation method/machine set forth in U.S. Pat. Nos. 5,173,352 and 5,403,259, the strips always have a rectangular unfolded shape and the same length.

The present invention provides these and other features hereinafter fully described and particularly pointed out in the claims. The following description and annexed drawings setting forth in detail certain illustrative embodiments of the invention, these being indicative, however, of but a few of the various ways in which the principles of the invention may be employed.

### BRIEF DESCRIPTION OF THE DRAWINGS

FIG. 1 is a schematic view of a method according of the present invention.

FIG. 2 is a schematic view of a transversely cut sheet material according to the present invention.

FIG. 3 is a schematic view of another method according to the present invention.

FIG. 4 is a schematic view of another transversely cut sheet material according to the present invention.

FIG. 5 is a schematic view of the unfolded form of a strip according to the present invention.

FIGS. 6A and 6B together form a schematic view of a machine according to the present invention.

FIG. 7 is a side elevation view of the transverse severing assembly of the machine illustrated in FIGS. 6A and 6B.

FIG. 8 is a front view of a cutting roller of the transverse severing assembly illustrated in FIG. 7.

FIG. 9 is an enlarged fragmentary side view of the cutting roller illustrated in FIG. 8.

FIG. 10 is a schematic view of a plurality of intermixed folded strips according to the present invention.

FIG. 11 is a schematic view of another transversely cut sheet material according to the present invention.

FIG. 12 is a schematic view of the unfolded form of a strip according to the present invention.

FIGS. 13A-13D are schematic views of a folding device for the machine of FIGS. 6A and 6B.

FIG. 14 is a schematic view of another folding device for the machine of FIGS. 6A and 6B.

### DETAILED DESCRIPTION OF THE INVENTION

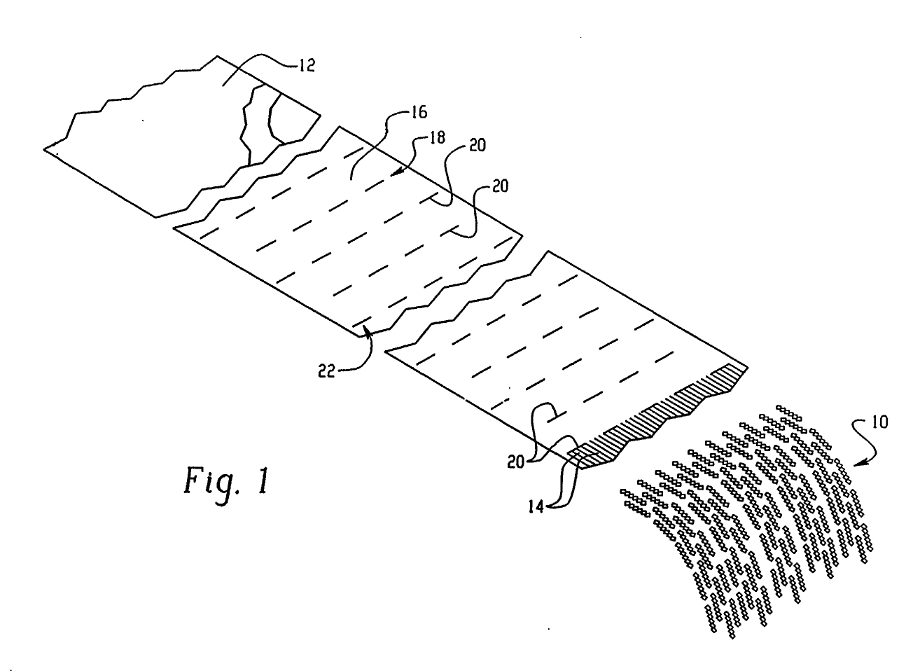

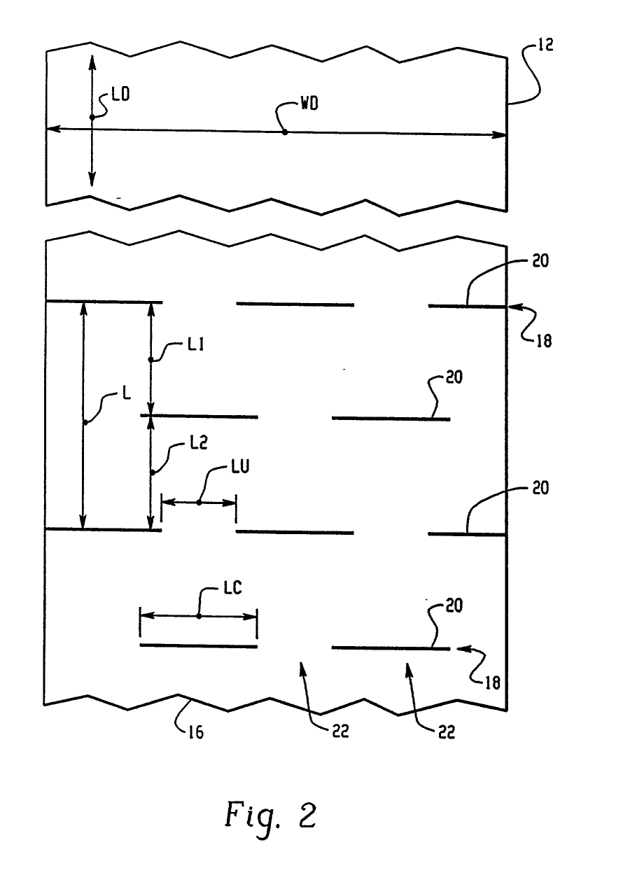

A method of making a plurality of accordion-folded strips 10 each having a predetermined unfolded length is schematically illustrated in FIGS. 1 and 2. In this method, a sheet of material 12 is longitudinally and transversely separated into a plurality of strips 14 of predetermined unfolded lengths, and the strips are folded to form the plurality of accordion-folded strips 10. The transverse separation of the strip occurs at completion of the longitudinal separation.

The sheet material 12 is preferably biodegradable, recyclable, and composed of a renewable resource. More particularly, the sheet material 12 is paper, and more preferably Kraft paper. Also, the sheet material 12 preferably is multi-ply and more preferably three ply paper. Additionally or alternatively, the sheet material 12 may be treated with a moistening and/or chemical treatment agent.

The sheet material 12 is formed into a pre-cut sheet material 16 having a plurality of transverse rows 18 of cuts 20 alternating with lengths of uncut material LU. The number of cuts 20 per row 18 is preferably minimized. The cuts 20 which form the transverse rows 18 also form longitudinal columns 22 of associated cuts 20 which are longitudinally aligned. An associated cut 20 is a cut 20 associated with at least one adjacent or proximate cut 20 in a column 22. Except at the leading and trailing edges of a sheet, each cut 20 is associated with two proximate or adjacent cuts in a column 22. A column 22 may also be viewed as formed from alternating cuts 20 and transverse lengths of uncut material LU which are part of alternating transverse rows 18. The cuts 20 in adjacent transverse rows 18 are longitudinally offset or staggered relative to one another.

The sheet material 12 may be formed into the pre-cut sheet material 16 at the same location as the longitudinally separating and folding steps are preformed. For example, as is explained in more detail below, a machine may incorporate a transverse severing assembly which forms the cuts 20 in the sheet material 12 to form the precut sheet material 16. Alternatively, the sheet material 12 may be cut to form the pre-cut sheet 16 at a location remote from where the longitudinal separating and folding steps occur and supplied in a continuous form at the location of the longitudinal separating and folding steps. For example, the pre-cut material may be supplied in a stock roll or as a fan-folded stack such as is disclosed in U.S. Pat. No. 5,387,173. (This patent is assigned to the assignee of the present invention and its entire disclosure is hereby incorporated by reference.)

The sheet material 12 has a longitudinal or length dimension LD and a transverse or width dimension WD. Longitudinally severing or slitting the transversely cut sheet material 16 results in a plurality of strips 14 each of the predetermined unfolded length L. Longitudinal separation of the strips 14 from the sheet material 16 forms at least one strip 14 and preferably a plurality of strips 14 between associated cuts 20 in longitudinal column 22. If the sheet material 16 is multi-ply, as is preferred, this longitudinal separating or severing step also will form a plurality of layered strips 14 between the associated cuts 20. The strips 14 are then folded to produce the accordion folded strips 10.

In the illustrated embodiment, at least three columns 22 of cuts 20 are formed across the width of the sheet material 16, and at least four strips 14 are formed between associated cuts 20. However, the number of strips 14 formed per cut 20 is a function of the length LC of the cut 20 and the width of the strips 14. Preferably, the material between a pair of the associated cuts 20 in a column 22 has a width of about five inches which is slit into ⅛ inch wide strips 14, producing at least forty strips 14 per pair of associated cuts 20. Several shorter strips 14 may be produced in regions of overlap at the distal ends of the cuts 20, as explained below.

In the embodiment illustrated in FIGS. 1 and 2, the cuts 20 in the sheet material 16 are positioned, oriented or arranged perpendicular to the longitudinal dimension LD of the sheet material 16 and are arranged in a longitudinally offset or staggered fashion. Also, the sum of the distances L1 and L2 between the adjacent transverse rows 18 of the cuts 20 equals the distance L between the associated cuts 20 in a column 22.

In the illustrated embodiment, the distances L1 and L2 between the adjacent transverse rows 18 are uniform whereby the folded strips 10 have the same unfolded length L. If strips of predetermined, but different, unfolded lengths are desired, the distances L1 and L2 between adjacent transverse rows 18 of cuts 20 may be arranged so that the distances therebetween correspond to such different unfolded lengths. The longitudinal distances L1 and L2 between adjacent rows 18 of cuts 20 need not be uniform, however, the minimum distance should be great enough to prevent premature separation of the sheet material.

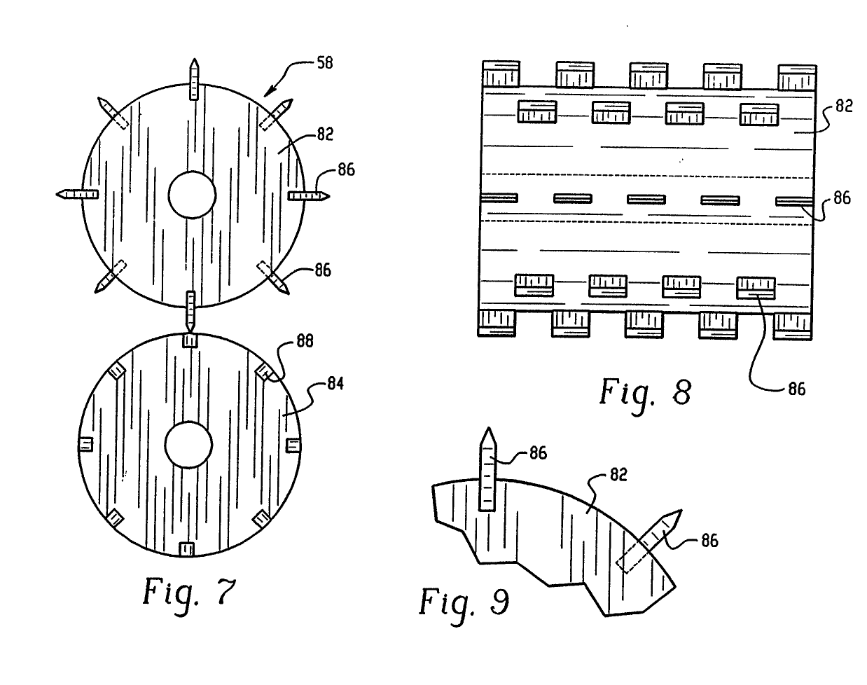

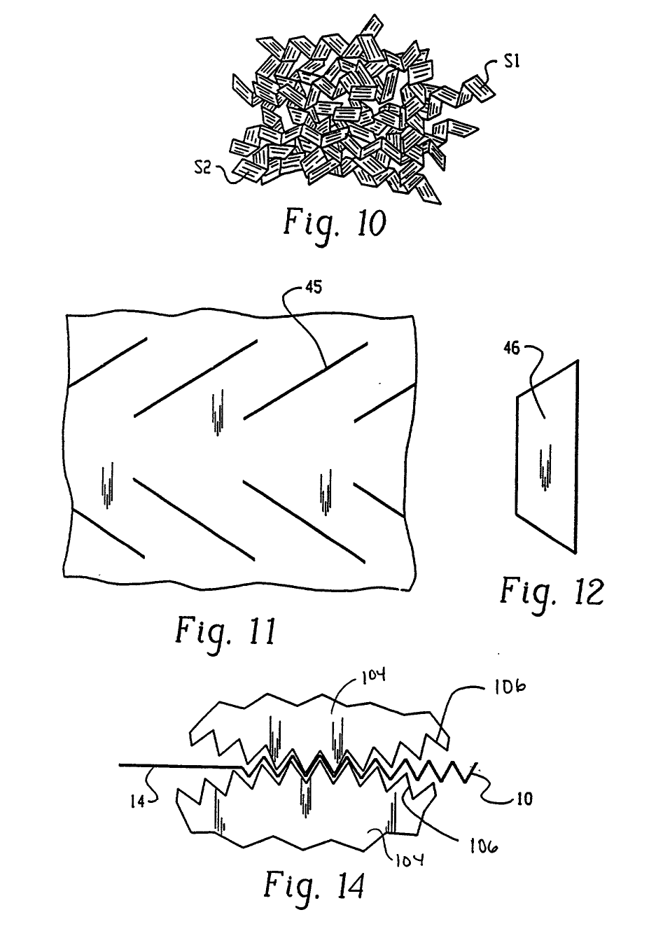

If strips of different unfolded lengths are produced, an intermixed plurality of strips of predetermined, but different, lengths will be produced, such as is shown FIG. 10. Specifically, for example, strip S1 would have one length corresponding to L and strip S2 would have a shorter different length corresponding to L2. A larger range of predetermined, but different, lengths may be obtained by separating associated cuts 20 in a range of distances on the sheet material 16.

If the pre-cut sheet material 16 is perfectly aligned and the distal ends of the cuts 20 in adjacent columns 22 are aligned, the strips 14 will have the same length L and will be completely severed by the cuts 20. In practice, however, it may be difficult to align the sheet material 16 consistently. Therefore, it is preferred that the distal ends of the cuts 20 overlap enough to insure that no partially cut strips 14 having a length greater than L are created, regardless of the transverse alignment of the sheet material 16. More preferably, the amount of overlap is approximately the width of one strip 14. With an overlap, a relatively small number of the strips 14 have a length less than L which is equal to the distance between overlapping distal ends of the cuts 20 in adjacent columns 22 (i.e., length L1 or L2 illustrated in FIG. 2). For example, if the distance between overlapping cuts 20 in an adjacent row 18 is ½ L, then in the region of overlap a small number of strips 14 will have lengths of ½ L.

The dimensions and arrangements of the cuts 20 are important for other reasons as well. When the sheet material 16 is pulled in the longitudinal direction during separation, it should not have a tendency to deform and become longer, narrower, and/or take on a greater overall thickness. The transverse distance between adjacent transverse cuts (i.e., the transverse length of the uncut material LU between the cuts 20 in a row 18), the length LC of the cut 20 and the longitudinal distance between adjacent rows 18 of cuts 20 combine to prevent expansion and deformation of the sheet material 16. Deformation is undesirable because it will increase the likelihood of premature separation, jam the machine, and/or result in unpredictable widths of strips 14. Preferably, the balance of these factors is such that the possibility that the sheet material 16 will separate or deform or make pulling the sheet material 16 difficult is minimized or eliminated. The distance of the overlap is substantially less than the distance between associated cuts 20.

The present invention provides a single step of longitudinal separation for forming strips 14 of predetermined lengths without complete transverse separation of a leading sheet portion from the leading end of a continuous web of sheet material, such as a stock roll or a fan-folded stack of stock material. However, a continuous web of sheet material is not required. The present invention also contemplates forming strips 14 of predetermined length from a discrete sheet that has a length long enough to provide a plurality of associated cuts 20.

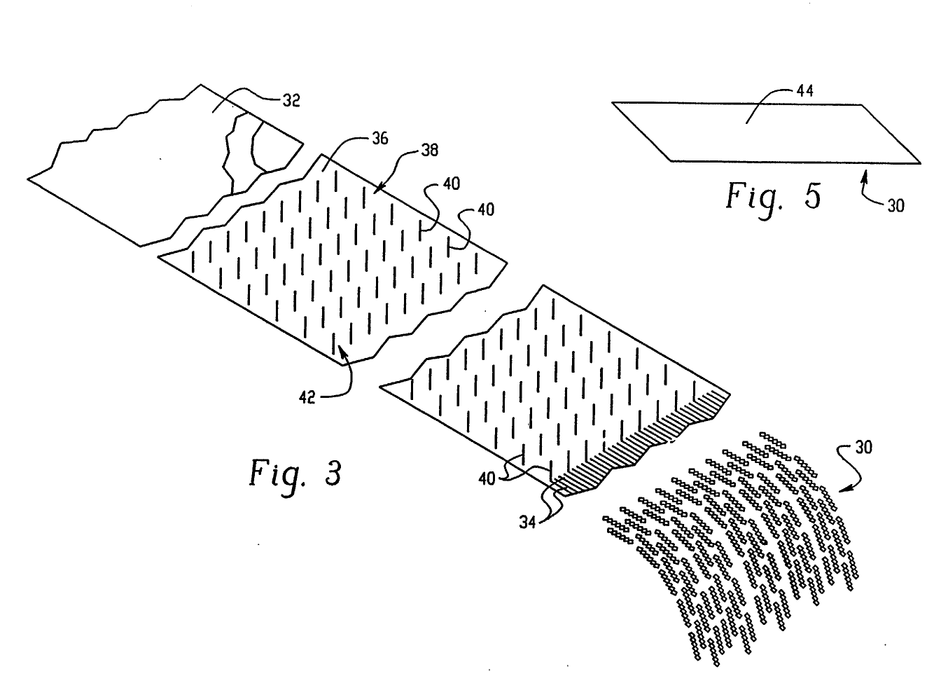

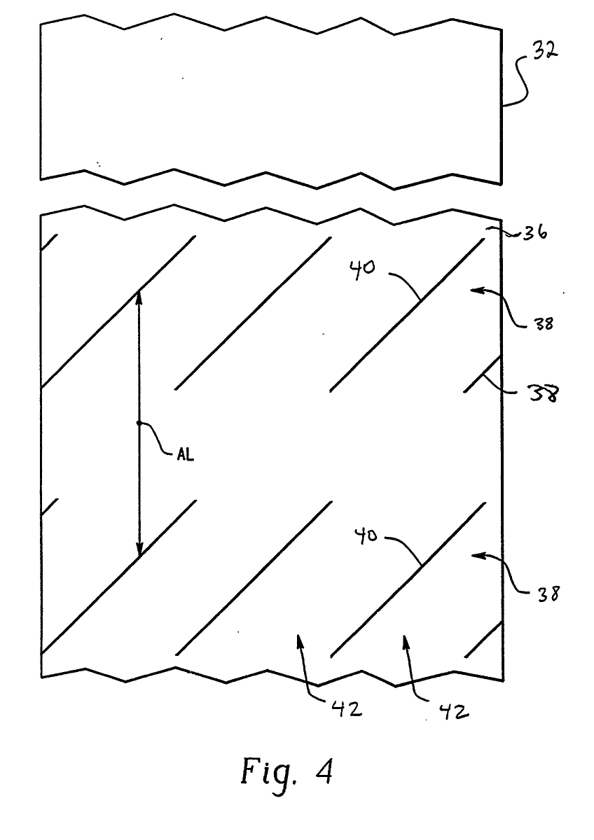

Referring now to FIGS. 3 and 4, a modified method of making a plurality of accordion-folded strips 30 having predetermined unfolded lengths is schematically illustrated. This method is similar in many ways to the method shown schematically in FIG. 1. Specifically, a sheet material 32 is also transversely and longitudinally separated into a plurality of strips 34 of predetermined unfolded lengths, and then the strips 34 are folded to form the plurality of accordion-folded strips 30. The longitudinal and transverse separation of the sheet material 32 is accomplished by supplying a sheet material 36 having a plurality of transverse rows 38 of cuts 40. The rows 38 in the transversely cut sheet material 36 include associated cuts 40 which are longitudinally aligned to form columns 42. The longitudinal distance between associated cuts 40 defines the unfolded length AL of the folded strips 30. The longitudinal and transverse separation step is completed by longitudinally severing or slitting the sheet material 36 to form at least one strip 34 (and preferably a plurality of strips) between associated cuts 40.

However, in the modified method illustrated schematically in FIGS. 3 and 4, the cuts 40 in the sheet material 36 are not positioned perpendicular to, but rather acutely angled relative to the sheet's longitudinal dimension. In other words, the cuts 40 are positioned at a non-zero and non-perpendicular angle relative to the sheet's transverse dimension. Preferably, the cuts 40 are angled between 5° and 85°, more preferably between 15° and 75°, and even more preferably between 30° and 60° relative to the transverse dimension. This angled arrangement of the cuts 40 allows associated cuts 40 in the longitudinal columns 42 to be positioned in adjacent rows 38 instead of alternating rows, while still maintaining the structural integrity of the sheet 36 such that the sheet material 36 can be pulled into and/or through the machine without complete transverse separation and without substantial deformation of the sheet material 36.

The plurality of accordion folded strips 30 produced by the process shown schematically in FIGS. 3 and 4 comprise a length of material having an unfolded planar area 44 in the shape of a non-rectangular quadrilateral (see FIG. 5) and more particularly a parallelogram. Specifically, the strip 30 includes two sets of opposite parallel sides formed by the slitting operation connected by non-perpendicular ends formed by the transverse separation or cuts 40 (see FIG. 5.) The two sides of the strip 30 formed by the longitudinal severing or slitting step are substantially longer than the two sides of the strip formed in the transverse severing or cutting step.

The cuts may be of different shapes and/or angled at different directions to form strips having transverse edges which are sloped, curved or otherwise non-perpendicularly arranged relative to the longitudinal edges whereby the strips will have non-rectangular unfolded shapes. For example, as shown in FIGS. 11 and 12, the associated cuts 45 may be angled oppositely relative to each other to form strips 46 having trapezoidal unfolded shapes. The associated cuts could be curved to form strips having roughly oblong unfolded shapes. These and other non-rectangular unfolded shapes are possible with, and contemplated by, the present invention.

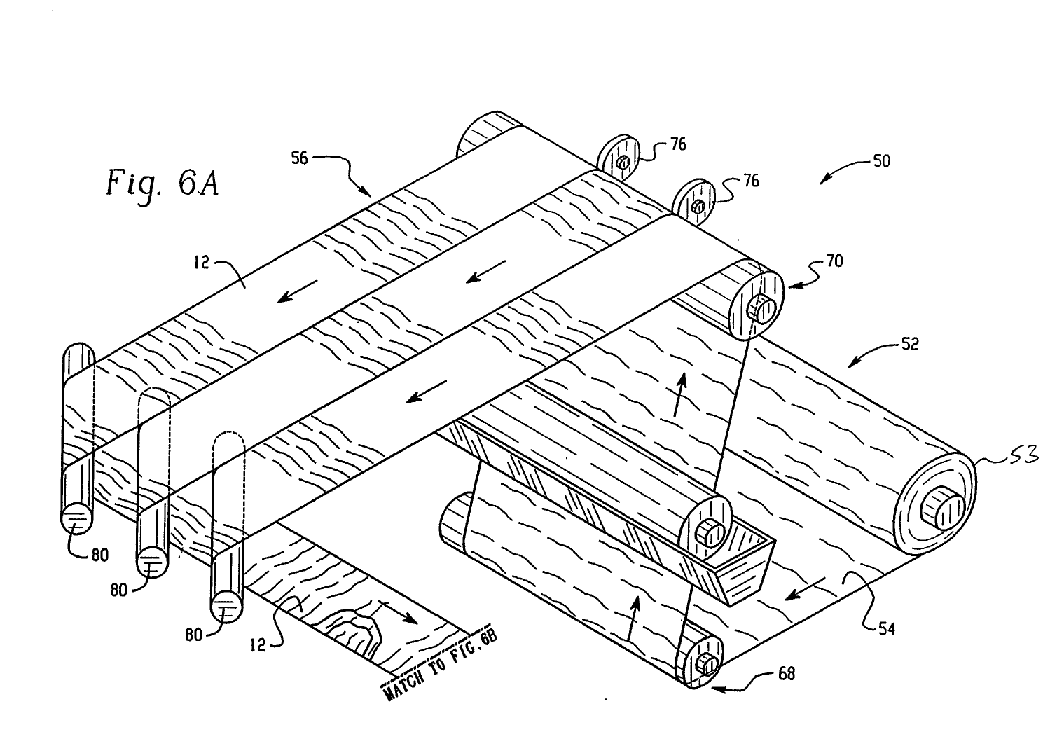

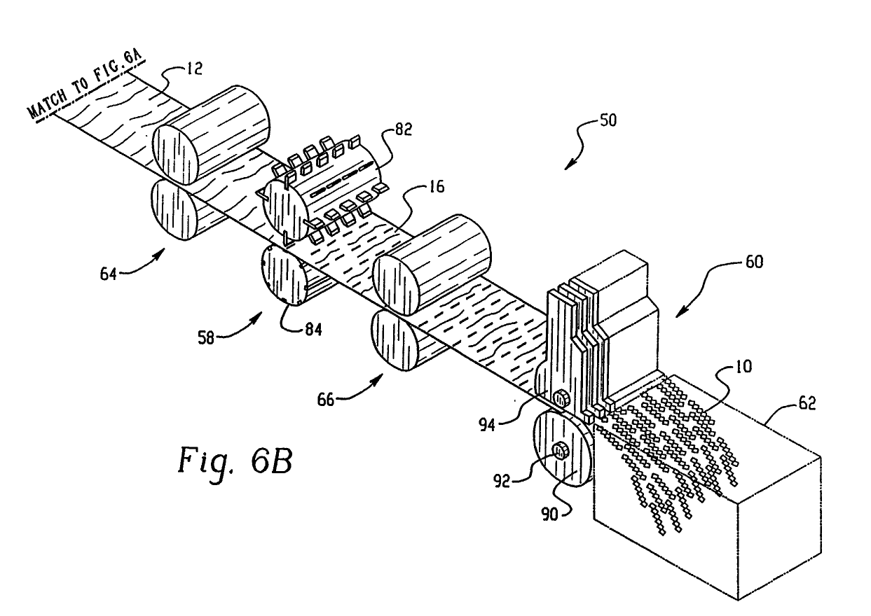

Referring now to FIGS. 6A and 6B, a machine 50 according to the present invention is schematically illustrated. The machine 50 is designed to produce a plurality of the accordion-folded strips 10 from a roll 53 of stock material 54. The machine 50 includes a stock supply assembly 52, a layering assembly 56, a transverse severing assembly 58, a longitudinal slitting (or severing) assembly 60, and a folding device 62 (schematically shown). The stock material 54 is pulled through various assemblies by first and second pulling roller assemblies 64 and 66, respectively, and is guided by idler roller 68 and slitting roller 70, respectively.

The stock material 54 travels from the stock supply assembly 52 over the slitting roller 70 to the layering assembly 56. The layering assembly 56 includes turner bars 80 which are mounted diagonal to the direction of movement of the sheet material 54. Slitting knives 76 are advantageously mounted near the slitting roller 70 to slit the web of stock material 54 longitudinally into a plurality of sheets of stock material 12. The turner bars 80 reorient and layer the sheets of stock material to form a multi-ply sheet material. The slitting roller 70 may also function as a backing roller by, for instance, having a urethane or hardened steel surface to provide appropriate backing for the cutting action of the knives 76. In any event, the stock material 54 is cut into three longitudinal segments which are advanced around the turner bars 80 and layered one on top of the other to form a multi-ply, in this case three ply stock material 12. A more detailed discussion of a suitable layering assembly is set forth in U.S. Pat. No. 5,656,008. Additionally or alternatively, if chemically treated folded strips are desired, a detailed discussion of a suitable treatment assembly is set forth in U.S. application Ser. No. 08/153,360.

Referring now to FIG. 6B, the stock material 12 then travels through the first pulling assembly 64 to the transverse severing assembly 58 and through the second pulling assembly 66. The transverse severing assembly 58 includes a cutting roller 82 and a backing cylinder 84 positioned between the first and second pulling assemblies 64 and 66, respectively. As more clearly shown in FIGS. 7-9, the cutting roller 82 includes blades 86 which are mounted on the main cylindrical body of the cutting roller 82 for rotation therewith. The backing cylinder 84 is in alignment with the cutting roller 82 and includes urethane or hardened steel sections 88 for specific alignment and cooperation with the blades 86. (The backing cylinder 84 may be replaced with, for example, a stationary anvil.) The blades 86 of the illustrated transverse severing assembly 58 are positioned to create the transversely cut sheet material 16 shown in FIGS. 1 and 2. As can be appreciated, the blades 86 would be appropriately rearranged and/or replaced to produce the sheet material 36 shown in FIGS. 3 and 4 and/or any other suitable arrangement of cuts in the sheet material 12.

In the preferred embodiment, the sharpened blades 86 are serrated and are used to make transverse rows 18 of cuts 20 in the sheet material 16, however, the scope of the present invention includes other means, for severing such as, for example, linear blades and/or smooth blades. In place of the cutting roller 82, a timed severing device which cuts the sheet material at controlled intervals may also be used.

As described above in the discussion of FIGS. 1 and 2, the pre-cut sheet material 16 may be formed at a remote location and supplied in a continuous form (i.e., a stock roll or fan-folded stack). If so supplied, a machine may omit the transverse severing assembly 58 and also the layering assembly 56. This omission would usually result in a simplified and smaller machine.

The transversely cut sheet material 16 then travels through the longitudinal severing assembly 60 wherein the longitudinal separation of the sheet is performed by longitudinally slitting the sheet material 16 to form at least one strip 14 (and preferably a plurality of strips) between associated cuts 20 which are longitudinally aligned.

The longitudinal severing assembly 60 includes an upper set (not shown) and a lower set (one shown) of overlapping slitting discs 90, which are fixedly mounted for rotation with respective shafts 92, and an upper set of combers 94 and a lower set of combers (not shown) which are fixedly mounted relative to the rotating shafts 92 (with limited movement possible). The overlapping and interengagement of the discs 90 are such that adjacent slitting discs on one shaft sandwich therebetween a portion of the associated slitting disc on the other shaft. The combers 94 include an end face in alignment with the corresponding slitting disc 90 on the opposite shaft 92 to form a passageway into the folding device 62. A more detailed discussion of suitable slitting discs and/or combers is set forth in U.S. Pat. No. 5,403,259.

The longitudinal severing assembly 90 slits the stock material sheet 16 into unfolded strips 14 (FIG. 1) of the desired length. These strips 14 are then advanced into the folding device 62 wherein they are folded into the desired accordion shape.

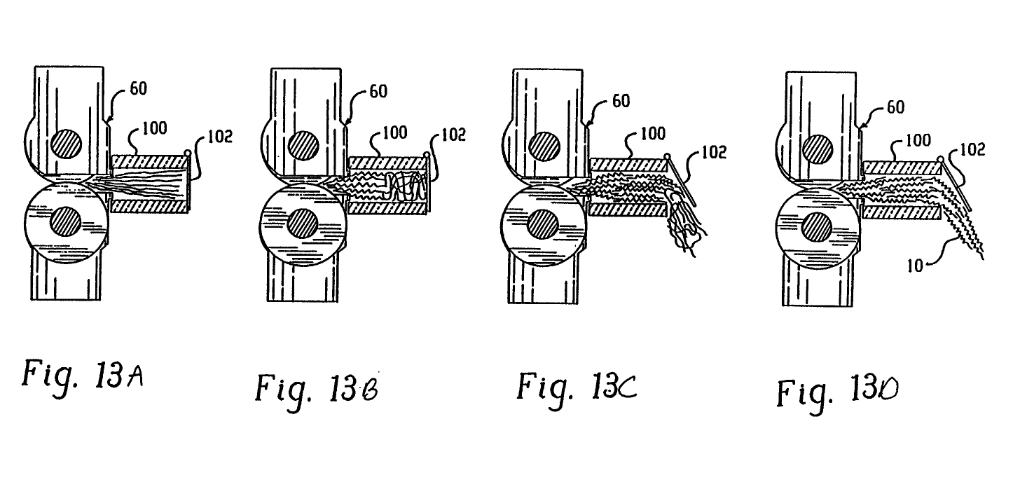

The folding may be accomplished by advancing the plurality of strips 14 against a restriction acting on the body of strips 14 in such a manner that the natural resilience of the material produces adjacent opposite folds thereby causing the strips 14 to assume substantially the same accordion or zig-zag shape. Referring now to FIG. 13, for example, the folding device 62 may comprise a chute 100 and a restriction 102. The chute 100 is aligned with the longitudinal slitting assembly 60 and maintained in position by framing (not shown) which may be secured at opposite sides of the longitudinal slitting assembly 60. The restriction 102 is initially formed by a physical barrier or gate at the discharge end of the chute 100, but as the folding process progresses, the already formed strips form the restriction. A more detailed discussion of such a folding device and process is set forth in U.S. Pat. Nos. 5,403,259 and 5,573,491.

The folding may alternatively be accomplished by positively forming the strips 14 into the desired accordion-folded shape. For example, the folding device 62 could comprise a set of mating rotating members 104 each having a radially outer surface 106 contoured in a zig-zag shape. As the rotating members 104 are turned in the appropriate downstream direction, the strip 14 passes between the contoured surfaces 106 which press-form the strip 14 into the desired accordion shape.

In addition to the above examples, the folding may instead be accomplished by any means or device which forms the strips into the desired folded shape. For example, instead of the folding being accomplished by advancing the plurality of strips 14 against a restriction acting on the body of strips, a restriction may act on individual strips, such as is shown in U.S. Pat. No. 2,537,026 to Brugger.

Although the invention has been shown and described with respect to certain preferred embodiments, equivalent alterations and modifications will occur to others skilled in the art upon the reading and understanding of this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiments of the invention. In addition, while a particular feature of the invention may have been described above with respect to only one of several illustrated embodiments, such feature may be combined with one or more other features of the other embodiments, as may be desired and advantageous for any given or particular application.

What is claimed is:

1. A method of making a plurality of accordion-folded strips each having a predetermined unfolded length, the method comprising the steps of:
longitudinally and transversely separating a sheet material into a plurality of strips each having a predetermined unfolded length; and
folding the strips into a plurality of accordion-folded strips;
wherein the transverse separation of the strip occurs at completion of the longitudinal separation.

2. A method according to claim 1, wherein the longitudinally and transversely separating step is accomplished by:
supplying a precut sheet material having a plurality of cuts forming longitudinal columns of longitudinally aligned associated cuts;
longitudinally severing the sheet material to form at least one strip between the associated cuts.

3. A method according to claim 2, wherein the longitudinally severing step includes forming a plurality of strips between associated cuts.

4. A method according to claim 2, wherein the supplying step includes supplying a pre-cut sheet material having cuts in adjacent transverse rows which are longitudinally offset, the transverse rows including a plurality of cuts separated by a length of uncut material.

5. A method according to claim 2, wherein the supplying step includes supplying a pre-cut sheet material having a longitudinal dimension and having cuts arranged at a non-zero and non-perpendicular angle relative to the longitudinal dimension.

6. A method according to claim 2, wherein the supplying step includes the steps of:
supplying an uncut sheet material; and
severing the sheet to form the pre-cut sheet material.

7. A method according to claim 2, wherein the supplying step includes supplying a continuous web of pre-cut sheet material.

8. A method according to claim 2, wherein the supplying step includes the step of supplying a pre-cut sheet material having transversely aligned cuts in alternate longitudinal columns.

9. A method according to claim 2, wherein the supplying step includes supplying a pre-cut sheet material that is biodegradable, recyclable and composed of a renewable resource.

10. A method according to claim 9, wherein the supplying step includes supplying a pre-cut sheet material that is paper.

11. A method according to claim 2, wherein the supplying step includes supplying a multi-ply sheet material whereby the longitudinally severing step includes forming a plurality of multi-layered strips between associated cuts.

12. A machine for making a plurality of accordion-folded strips each having a predetermined unfolded length, the machine comprising:
a transverse severing assembly and longitudinal severing assembly which transversely and longitudinally separate a sheet of material into a plurality of strips each having a predetermined unfolded length; and
a folding device, located downstream of the longitudinal severing assembly which causes folding of the strips into a plurality of accordion-folded strips;
wherein the transverse severing assembly cuts a plurality of cuts forming longitudinal columns of longitudinally aligned associated cuts in the sheet material;
wherein the longitudinal severing assembly is located downstream of the transverse severing assembly and longitudinally severs sheet material; and
wherein the transverse severing assembly arranges the cuts so that transverse separation of each strip occurs at completion of its longitudinal separation.

13. A machine according to claim 12, wherein the longitudinal severing assembly forms a plurality of strips between associated cuts.

14. A machine according to claim 12, wherein the transverse severing assembly forms a plurality of transverse rows including a plurality of cuts separated by uncut material, the cuts in adjacent transverse rows being longitudinally offset.

15. A machine according to claim 12, wherein the transverse severing assembly forms cuts which are angled relative to the longitudinal direction.

16. A machine according to claim 12, wherein the longitudinal severing assembly forms strips having an unfolded length equal to the distance between associated cuts.

17. A machine according to claim 12, wherein the folding device comprises a folding chamber in which the strips are restricted in such a manner that the natural resilience of the sheet material produces adjacent opposite folds thereby causing the strips to assume substantially the same accordion shape.

18. A machine according to claim 12, wherein the folding device comprises a positive forming die corresponding to the desired accordion folded shape.

19. A plurality of accordion-folded strips comprising lengths of sheet material formed into a plurality of transverse folds, at least some of the lengths of sheet material including, in an unfolded state, transverse edges which are non-perpendicularly sloped relative to the longitudinal edges of the length of material whereby at least some of the strips have a non-rectangular unfolded shape.

20. A plurality of accordion-folded strips as set forth in claim 19 wherein the material is paper.

21. A plurality of accordion-folded strips as set forth in claim 19 wherein the strips have a transverse dimension and a longitudinal dimension which is substantially longer than its transverse dimension.

22. A plurality of accordion-folded strips as set forth in claim 19 wherein the unfolded shape of at least some of the strips is a parallelogram.

23. A plurality of accordion-folded strips as set forth in claim 19 wherein the unfolded shape of at least some of the strips is a trapezoid.

24. A plurality of accordion-folded strips formed by a process comprising the steps of:
supplying a pre-cut sheet material having cuts angled relative to the longitudinal direction of the sheet material;
longitudinally separating the pre-cut sheet material between the angled cuts to form a plurality of strips each having a predetermined unfolded length; and
folding the strips into a plurality of accordion-folded strips.

25. A plurality of accordion-folded strips according to claim 24, wherein the supplying step includes supplying a sheet material having cuts angled between five and eighty-five degrees relative to the longitudinal direction.

26. A plurality of accordion-folded strips according to claim 25, wherein the supplying step includes supplying a sheet material having cuts angled between fifteen and seventy-five degrees relative to the longitudinal direction.

27. A plurality of accordion-folded strips according to claim 26, wherein the supplying step includes supplying a sheet material having cuts angled between thirty and sixty-five degrees relative to the longitudinal direction.

28. A material for forming a plurality of accordion-folded strips by longitudinally separating the material into a plurality of strips each having a predetermined unfolded length and then folding the strips into a plurality of folded strips, the material comprising:
a substantially planar sheet having a plurality of transverse rows of cuts, the rows including a plurality of cuts separated by a length of uncut material, the cuts in adjacent rows being longitudinally offset, and the plurality of transverse rows forming longitudinally aligned columns of associated cuts;
the cuts being arranged to prevent expansion and deformation of the sheet material.

29. A material as set forth in claim 28 wherein the planar sheet is paper.

30. A material for forming a plurality of accordion-folded strips by longitudinally separating the material into a plurality of strips of a predetermined unfolded length and then folding the strips into a plurality of folded strips, the material comprising:
a substantially planar sheet having a plurality of transverse rows of cuts having a non-perpendicular and non-zero angle relative to a longitudinal dimension of the sheet;
wherein the cuts form longitudinally aligned columns of associated cuts.

31. A material as set forth in claim 30 wherein the planar sheet is paper.

32. A plurality of accordion-folded strips each comprising a length of sheet material formed into a plurality of transverse folds;
the strips having predetermined, but different, unfolded lengths;
the strips of different unfolded lengths being intermixed.

33. A material as set forth in claim 32 wherein the planar sheet is paper.

34. A material as set forth in claim 32 wherein the strips have a rectangular unfolded shape.

35. A method of making a plurality of accordion-folded strips each having a predetermined unfolded length, the method comprising the steps of:
cutting a sheet of material to provide at least one cut that has a dimension extending along a portion of a width dimension of the sheet material;
longitudinally separating the sheet material, wherein a section of the sheet material along the width dimension is transversely separated into a plurality of strips each having a predetermined unfolded length as longitudinal cuts from the longitudinal separation intersect the at least one cut; and
folding the strips from the section of transversely separated sheet material into a plurality of accordion folded strips.
